(19) United States
(12) Patent Application Publication
(10) Pub. No.: US 2007/0145632 A1
(43) Pub. Date: Jun. 28, 2007

(54) Elastomeric stamp, patterning method using such a stamp and method for producing such a stamp

(75) Inventors: Emiel Peeters, Eindhoven (NL); Dirk J. Broer, Geldrop (NL); Fredericus C. Van Den Heuvel, Waalre (NL); Dirk Burdinski, Essen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.C.

(21) Appl. No.: 10/575,797

(22) PCT Filed: Oct. 7, 2004
(86) PCT No.: PCT/IB04/52010

§ 371 Date: Apr. 13, 2006

(30) Foreign Application Priority Data
Oct. 11, 2003 (GB) 0323903.5

(51) Int. Cl. B29C 33/40

(52) U.S. Cl. 264/219

(57) ABSTRACT

An elastomeric stamp (10) for printing a pattern on a substrate (500) with an ink (520) is at least partially formed from a first material such as PDMS. The stamp comprises a first surface (12) in a first plane, a second surface (14) in a second plane and a third surface (16) extending from the first surface (12) to the second surface (14). The first surface (12) typically forms to the contact surface of a protruding feature of the stamp (10), whereas the third surface (16) typically forms the edge of such a feature. The first surface (12) comprises a barrier layer (22) being substantially impermeable to the ink (520). Optionally, the second surface (14) may carry a further barrier layer (24) to suppress gas phase diffusion of the ink (520). In contrast, the third surface (16) is permeable to the ink (520). Consequently, a stamp (10) is obtained that is highly suitable for edge transfer lithography type patterning. The first material of the stamp serves as an ink reservoir, thus reducing the re-inking frequency of the stamp, and the layer (22) prevents unwanted diffusion of the ink (520) to the areas of the substrate (500) into contact with the stamp (10), thus 20 improving the feature definition on the substrate surface.

The present invention relates to an elastomeric stamp for printing a pattern on a substrate with an ink, the stamp being at least partially formed from a first material and comprising a first surface in a first plane, a second surface in a second plane and a third surface extending from the first surface to the second surface.

The present invention also relates to a method for patterning a substrate of a device with an ink using such a stamp.

The present invention further relates to a method for producing such a stamp.

Traditionally, microscopic patterns of devices including electronic devices have been formed using lithographic steps involving masks to define these patterns on the substrates of the electronic devices. However, the production of masks is an expensive process, and with the downscaling of semiconductor feature sizes, as also predicted by Moore's Law, the patterns to be formed on the substrate have become increasingly complex, which usually resulted in the requirement of a larger number of masks, thus further increasing the production cost of the electronic devices. In addition, it is generally believed that the aforementioned traditional lithographic techniques have matured to such an extent that the further reduction of the feature sizes on the substrates of the electronic devices will be difficult to achieve with these techniques.

Alternative techniques for patterning the substrates of the electronic devices have been developed in an attempt to limit the production cost of the devices as well as to allow for even smaller features to be defined on the substrates. An example of such a technique is microcontact printing. This technique is based on forming the desired pattern of features on a surface of an elastomeric stamp, thus yielding a stamp having a patterned surface with protruding regions separated by cavities. Subsequently, the patterned stamp surface is inked with a suitable ink solution, after which the ink is transferred to a surface of the substrate of the electronic device by bringing the patterned surface of the stamp into contact with the substrate surface. The ink molecules selectively adhere to the substrate surface in the contact regions predefined by the stamp pattern. A self-assembled monolayer (SAM) is formed, which should be stable enough to withstand subsequent etching steps, in which the SAM operates as an etching mask. Alternatively, the patterned SAM may function as an anchor for the addition of further layers on top of the SAM. An example of a microcontact printing technique is disclosed in J. Phys. Chem. B 102, p. 3324 (1998) by Delamarche et al.

A known disadvantage of microcontact printing is the occurrence of unwanted ink diffusion such as lateral diffusion from the parts of the substrate surface that are into contact with the protruding regions of the stamp to parts of the substrate surface opposite the cavities of the stamp, as well as air-to-surface diffusion of the ink from the cavities of the stamp to opposite substrate surface areas. This blurs the feature definition, thus limiting the possible miniaturization of the feature sizes on the substrate.

An alternative mask printing technique is disclosed in PCT patent application WO 02/085639 A1, in which a patterned elastomeric stamp is exposed to a mixture of a desired ink and a polar solvent. Rather than soaking the stamp in an ink solution, a polar solvent having a low affinity with the elastomeric material is chosen, which results in the dewetting of the protruding stamp surfaces and the accumulation of the ink/solvent mixture in the cavities between the protruding regions of the stamp. After evaporation of the solvent, the protruding surfaces of the stamp are brought into contact with the substrate and ink is transferred to the substrate via the side edges of the protruding features of the stamp. This technique is sometimes referred to as Edge Transfer Lithography (ETL). However, in this particular technique, the dewetting step leaves traces of the ink on the protruding surfaces of the stamp, which can also cause blurring of the features printed on the substrate. Furthermore, since the volume of the ink reservoir on the ETL stamp is limited, ink has to be reapplied to the stamp on a regular basis, which hampers the industrial applicability of the technique. In addition, only a few hydrophilic ink solutions exhibit the desired dewetting behaviour on the stamp, which also limits applicability of the ETL technique.

The present invention seeks to provide an elastomeric stamp according to the opening paragraph having improved printing characteristics.

The present invention further seeks to provide a method of producing such an improved stamp.

The present invention also seeks to improve the device patterning method of the opening paragraph.

According to a first aspect of the invention, there is provided an elastomeric stamp for printing a pattern on a substrate with an ink, the stamp being at least partially formed from a first material, the stamp comprising a first surface in a first plane, a second surface in a second plane and a third surface extending from the first surface to the second surface, the third surface being permeable to the ink, the first surface comprising a barrier layer being substantially impermeable to the ink.

Such a stamp has a number of advantages over prior art stamps. First of all, because the first surface has become impenetrable to the ink due to the presence of the barrier layer, the first material, e.g., poly(dimethylsiloxane) (PDMS) or another suitable stamp material, may be used as an ink reservoir for the printing process, with the ink being transferred from the first material to the substrate on which the ink is deposited via the third surface, i.e., an edge of the stamp surface, rather than the ink being accumulated outside the first material in the recesses of the stamp. This has the advantage that the stamp has to be re-inked far less often than the prior art ETL stamps, which improves the industrial applicability of the stamp of the present invention. Furthermore, with the ink being stored inside the stamp, the stamp surfaces, and in particular the first surface, which is the contact surface with the substrate during printing, can be cleaned more thoroughly prior to the printing, which improves the resolution of the patterns to be printed on the substrate because smudging is less likely to occur. Also, due to the fact that no dewetting is required to ensure that the presence of ink is limited to the appropriate areas of the stamp, the stamp of the present invention is suited for use with a wider variety of inks than the stamp disclosed in PCT patent application WO 02/085639 A1.

It is emphasized that in the context of the present invention, a barrier layer that is substantially impermeable to an ink is to include a barrier layer in which the diffusion coefficient of that ink that is at least a decade smaller than the corresponding diffusion coefficient of the ink in the first material. If the diffusion coefficient of the ink in the material of the barrier layer is much smaller than in the first material, the ink diffusion through the barrier layer will be negligible on the timescales of the printing process for which the stamp is to be used.

The stamp of the present invention may be patterned by any known patterning technique, for instance by using a master having a first surface in a first plane, a second surface in a second plane and a third surface extending from the first surface to the second surface, i.e., a master having an inverse pattern compared to the pattern of the elastomeric stamp. Subsequently, the barrier layer may be formed on the first surface in a number of ways. The barrier layer may include an inorganic oxide such as a metal oxide, which may be formed by anisotropic deposition of the metal on the first surface and, optionally, on the second surface in the form of a metal, e.g., titanium, which may be oxidized in a subsequent processing step by exposing the metal to an oxygen source, e.g., an oxygen plasma. Alternatively, the metal oxide may be deposited directly on the first surface.

Alternatively, the barrier layer may include a layer of a polymer material, which has the advantage that it can be easily applied. Such a barrier layer may be formed by spin coating the polymer material onto a carrier in an uncured form, followed by adhering the uncured polymer to the first surface, for instance by dipping the first surface in the uncured polymer layer, after which the polymer is cured on the first surface. An alternative way of forming such a polymer layer is by depositing a precursor of the polymer material on the first surface of the elastomeric stamp and forming the layer of the polymer material from the precursor in a subsequent step. Prior to the formation of the layer of the polymer material from the precursor, a polymerization initiator may be deposited on the first surface of the elastomeric stamp.

An advantageous alternative way of forming the polymer layer on the first surface of the elastomeric stamp is by modifying the first surface of the master and depositing the precursor of the polymeric material on the first surface of the master prior to depositing the first material precursor on the surfaces of the master. The first surface of the master is modified to enhance the wetting of the first surface of the master with the precursor of the polymer material. Hence, the elastomeric stamp and the polymer barrier layer on the first surface of the elastomeric stamp or a precursor thereof can be formed in a one-step process, which can be easily repeated due to the presence of the modified first surface on the master.

The barrier layer may also include the first material in a modified form, which for instance may be obtained by exposing the first surface of the stamp to an oxidizing agent such as a peroxide. Depending on the nature of the first material, other modifications such as a reduction of the material or the reaction of the material to a further material are equally feasible.

In a preferred embodiment, the second surface comprises a further barrier layer being substantially impermeable to the ink. This has the advantage that through air diffusion of the ink from the second surface to a substrate is effectively prevented, thus yielding a better definition of the features printed on the surface. Consequently, the distance between the first plane and the second plane as defined by the third surface can be reduced, which has the advantage that the protruding features of the elastomeric stamp become more rigid, thus enhancing the robustness of the elastomeric stamp during printing. The further barrier layer may be formed from the same material as the barrier layer.

Advantageously, the first surface and the third surface form an angle between 60-90°. A negative slope from the first surface to the second surface, which is achieved when the angle between the first surface and the third surface is smaller than 90°, reduces the unwanted deposition of a material on the third surface.

At this stage, it is pointed out that US patent application US 2002/0098364 A1 discloses a silicone elastomeric stamp having a contact surface which is modified by an oxygen plasma, after which the modified contact surface is covalently bound to a hydrophilic polymer to provide the stamp with a hydrophilic contact surface. It will be appreciated by those skilled in the art that the stamp of the present invention differs in a number of non-obvious ways from the stamp disclosed in US 2002/0098364 A1, which for instance does not necessarily provide the contact surface of the stamp with an impermeable layer. Furthermore, the hydrophilic surface layer of the stamp disclosed in US 2002/0098364 A1 is grafted to the stamp contact surface, which is not necessary for the additional layers of the stamp of the present invention. Also, the aim of US 2002/0098364 A1 is to provide a stamp enabling the use of hydrophilic inks for microcontact printing, whereas the stamp of the present invention primarily seeks to provide a new printing technique in which advantageous aspects of ETL printing are combined with advantageous aspects of microcontact printing.

According to a further aspect of the invention, there is provided a method for printing an ink in a pattern on a substrate of an electronic device using an elastomeric stamp, the elastomeric stamp being at least partially formed from a first material, the elastomeric stamp comprising a first surface in a first plane, a second surface in a second plane and a third surface extending from the first surface to the second surface, the third surface being permeable to the ink, the first surface comprising a barrier layer being substantially impermeable to the ink, the method comprising the steps of: bringing the elastomeric stamp into contact with a supply of an ink solution; absorbing the ink solution in the first material; cleaning at least the barrier layer of the elastomeric stamp; drying the elastomeric stamp; and forming at least a part of the pattern by placing the elastomeric stamp on the substrate with the barrier layer contacting the substrate and transferring the ink from the first material to the substrate via the third surface.

The method of the present invention has the advantage that more substrates may be patterned without re-inking the stamp. In addition, the patterns on the substrate have a better resolution than achievable with the aforementioned prior art ETL technique, because the barrier layer of the stamp can be more rigorously cleaned prior to printing, for instance by rinsing the stamp with a suitable solvent, e.g., ethanol in case of sulfur containing inks including thiol based inks.

The invention is described in more detail and by way of non-limiting examples with reference to the accompanying drawings, wherein:

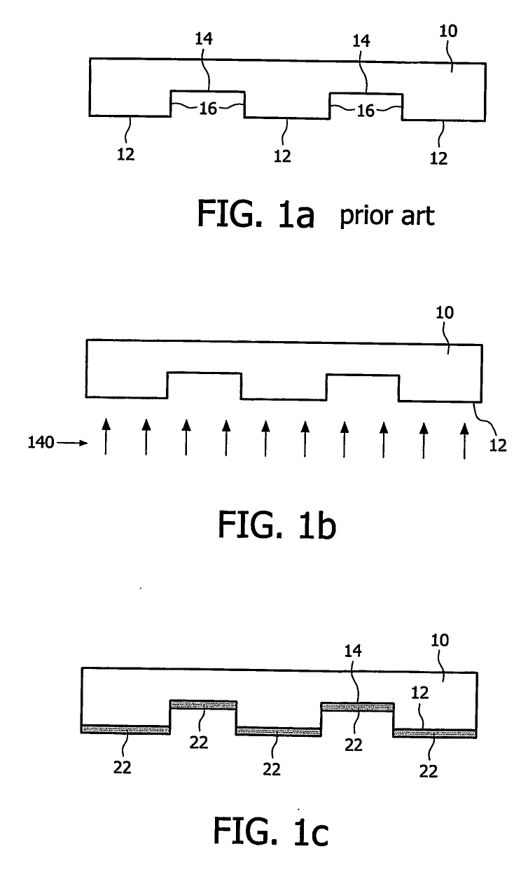

FIG. 1a-c depict an embodiment of an elastomeric stamp of the present invention and its production process;

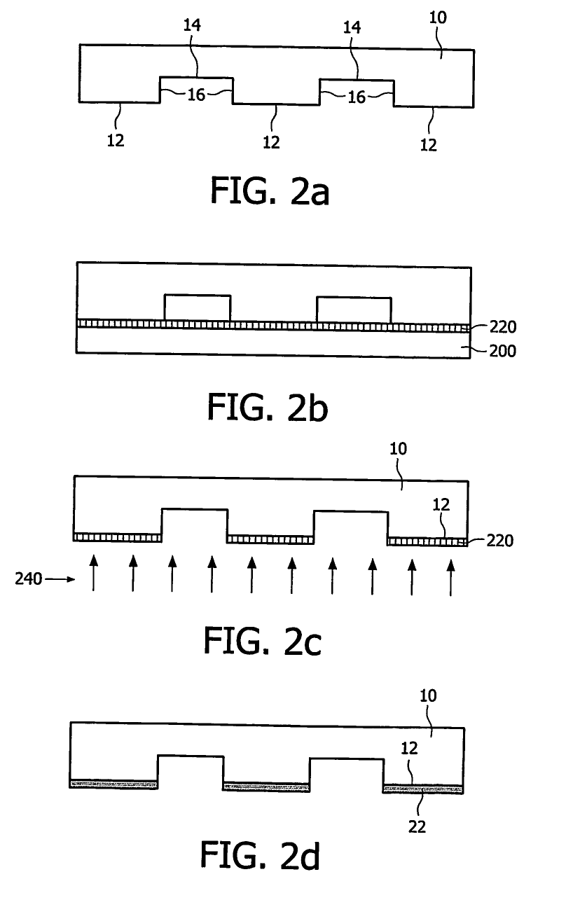

FIG. 2a-d depict another embodiment of an elastomeric stamp of the present invention and its production process;

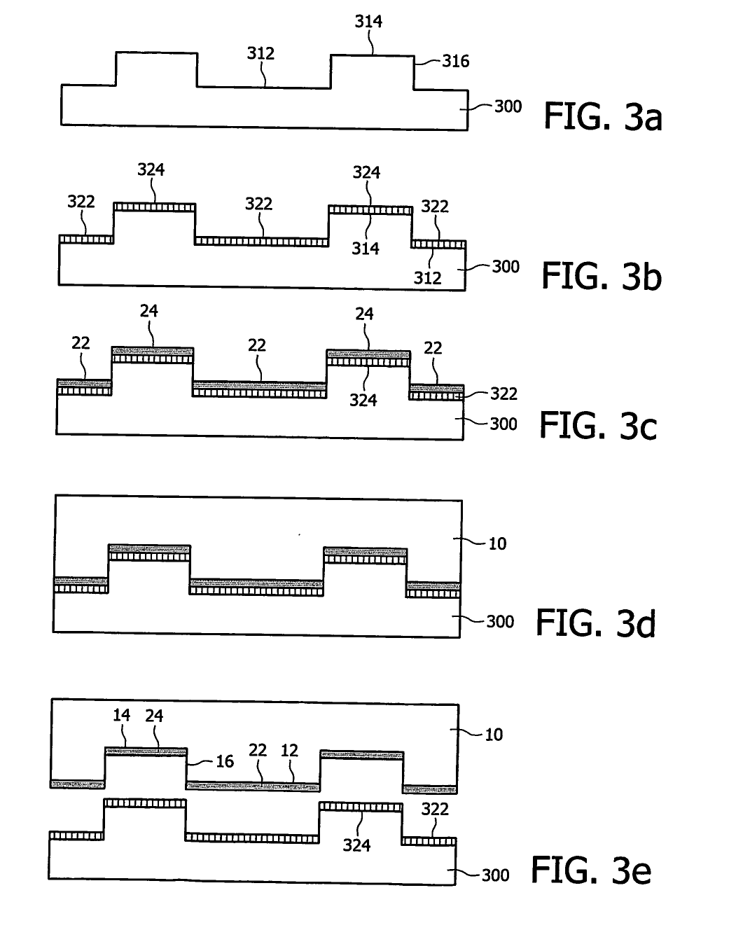

FIG. 3a-e depict yet another embodiment of an elastomeric stamp of the present invention and its production process;

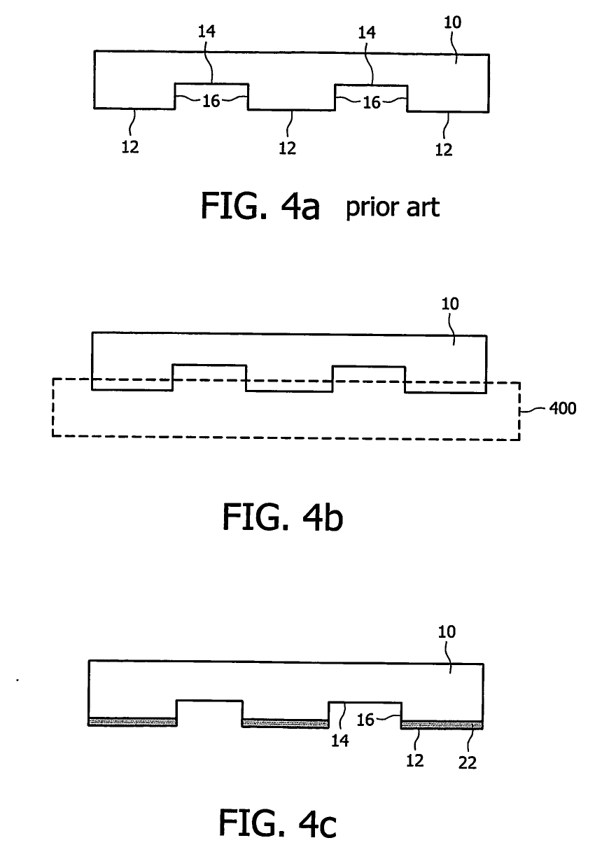

FIG. 4a-c depict yet another embodiment of an elastomeric stamp of the present invention and its production process; and

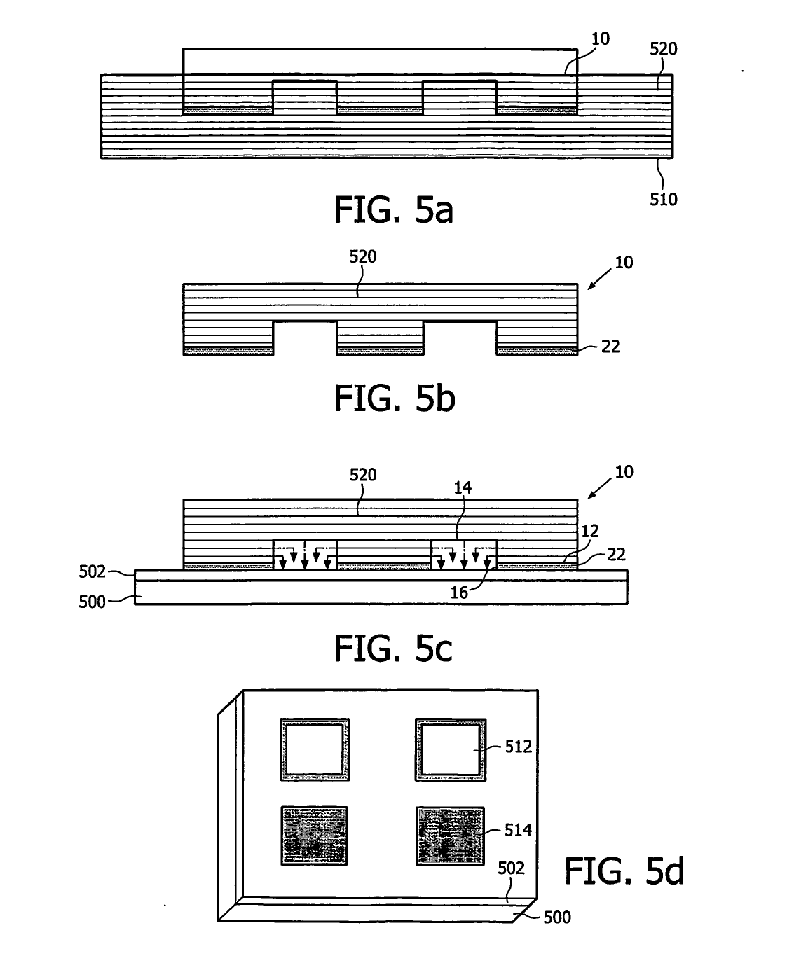

FIG. 5a-d depict an embodiment of the printing process using an elastomeric stamp of the present invention.

It should be understood that the Figures are merely schematic and are not drawn to scale. It should also be understood that the same reference numerals are used throughout the Figures to indicate the same or similar parts.

In FIG. 1a, an elastomeric stamp 10 is shown. The stamp has a first surface 12 in a first plane, a second surface 14 in a second plane and a third surface 16 extending from the first surface 12 to the second surface 14. The third surface 16 typically defines an edge of a protruding feature of the stamp 10, while the first surface 12 typically defines the contact surface of such a protruding feature. Typically, a plurality of first surfaces 12, second surfaces 14 and third surfaces 16 are likely to be present in a patterned elastomeric stamp 10. The elastomeric stamp 10 including the first surface 12, second surface 14 and third surface 16 is at least partially formed from a suitable material such as PDMS, or similar curable or thermoplastic materials, which are permeable to the ink, that is, have the ability to absorb the ink used in the printing process.

According to the present invention, the stamp 10 is exposed to an anisotropic deposition 140 of a second material or a precursor thereof, as shown in FIG. 1b. For instance, a layer of a few nm, e.g., 5 nm thickness of titanium may be anisotropically deposited on a PDMS stamp 10, thus only covering the surfaces perpendicular to the deposition direction, i.e., the first surface 12 and the second surface 14. Subsequently, the titanium layer is oxidized by exposure of the modified stamp 10 to an oxygen plasma for 1 minute at 300 Watt, thus yielding a stamp 10 as shown in FIG. 1c, in which the first surface 12 is covered by a barrier layer 22 and the second surface 14 is covered by a further barrier layer 24 of titanium dioxide. The exposure of the stamp 10 to the oxygen plasma can be of an isotropic nature, because the unwanted occurrence of the oxidation of the first material on the third surface 16 is a reversible process, as for instance is disclosed in US patent application US 2002/0098364.

It will be appreciated by those skilled in the art that the thickness of the barrier layer 22 and the further barrier layer 24 as well as the materials used to form said barrier layers may be varied without departing from the scope of the present invention. Additionally, a mask may be used in the anisotropic deposition step to ensure that the second material or precursor thereof is only deposited on the first surface 12, in which case the further barrier layer 24 may not be formed. Also, mask steps may be used to ensure that the barrier layer 22 and the further barrier layer 24 are formed from different materials. Furthermore, additional processing steps, e.g., chemical modification of the formed barrier layers, are feasible without departing from the scope of the present invention.

Although FIG. 1 and subsequent Figs show embodiments of an elastomeric stamp 10 having right angles between the first surface 12 and the third surface 16, it is pointed out that this is by way of non-limiting example only. The selective deposition, for instance by means of vapour deposition, of the barrier layer 22 and the further barrier layer 24 on the first surface 12 and the second surface 14 respectively of the stamp can be facilitated by giving the protruding features of the stamp a small negative slope, as defined by the angle between the first surface 12 and the third surface 16. Preferably, the first surface 12 and the third surface 16 form an angle between 60-90°. This way, the third surfaces 16 of the elastomeric stamp 10 encounter improved shielding from an evaporate coming from a point or a line source.

The production of an elastomeric stamp 10 having a sharp angle rather than a right angle between a first surface 12 and a third surface 16 is somewhat more difficult due to the fact that its release from a master, which typically is formed from a metal or silicon, can be hampered by locking or anchoring effects. However, when materials like silicone rubber or low-modulus polyurethane rubbers are chosen as a first material for the elastomeric stamp 10, the shapes are compliable enough to release the elastomeric stamp 10 from its initial master. Alternatively, a compliable master can be used, e.g., of silicone or polyurethane rubber, to facilitate the release of the elastomeric stamp 10 from the master.

FIG. 2 shows an alternative way of forming a barrier layer 22 on the first surface 12. The same stamp 10 as shown in FIG. 1a is again depicted in FIG. 2a. As shown in FIG. 2b, the stamp 10 is modified by dipping the first surface 12 in a layer of an uncured polymer 220, which has been deposited on a carrier 200. Such a polymer may be formed from epoxides, acrylates or other suitable compounds. This deposition may for instance be realized by means of a spin coating technique, with the thickness of the layer being controlled by the parameters of the spin coating process, e.g., polymer concentration, and spinning conditions such as rotation speed, temperature and so on. The layer of the uncured polymer typically has a submicron thickness, e.g., 50-100 nm.

Subsequently, the stamp 10 is removed, as shown in FIG. 2c and the uncured polymer 220 sticking to the first surface 12 is cured by subjecting it to an appropriate stimulus 240, e.g., UV or visible light, heat, electron beam or time in the case of a polymer curing at room temperature. The curing step of the polymer 220, which typically causes the formation of a polymer network, leads to the formation of a barrier layer 22 on the surface 12 of the stamp 10. The polymer based barrier layer 22 may be a separate surface layer or may be network penetrating the first material to a limited extent. The use of a polymer has the advantage that it can be applied without having to use vacuum conditions in the production process of the elastomeric stamp 10, which usually are required for the anisotropic deposition shown in FIG. 1b. The only prerequisite for the cured polymer is that the diffusion coefficient for the ink to be used is much lower in the cured polymer than in the first material of the stamp in order to provide an impermeable barrier for the ink at the timescales of the printing process.

The uncured polymer may also be deposited in the form of a polymer precursor material, i.e., a reactive monomer, and may be anisotropically deposited to the first surface 12 as well as on the second surface 14 to enable the formation of a barrier layer 22 on the first surface 12 and a further barrier layer 24 of the second surface 14. If required, a subsequent step of depositing an appropriate polymerization initiator such as a metal carbonyl, e.g., cobalt hexacarbonyl (Co(CO)₆) on the surfaces of the elastomeric stamp can be applied. This may also be an anisotropic deposition step, although this is not necessary if the polymer precursor itself has been deposited anisotropically.

An alternative way of forming a polymer barrier layer on a surface of stamp 10 is shown in FIG. 3. A master 300 for forming an elastomeric stamp has a first surface 312 in a first plane, a second surface 314 in a second plane and a third surface 316 extending from the first surface 312 to the second surface 314, as shown in FIG. 3a. The master 300 may be formed from a suitable material such as silicon.

In FIG. 3b, the first surfaces 312 and the second surfaces 314 of the master 300 have been modified by the application of respective wetting layers 322 and 324. This modification may be achieved by anisotropic deposition of a suitable wetting material, e.g., a fluorosilane on said surfaces. In a next step, a polymer precursor material having a high affinity with the wetting layers 322 and 324 is deposited on the master 300, for instance by means of spincoating. The high affinity of the polymer precursor material with the wetting layers 322 and 324 causes the dewetting of the surfaces of the master 300 that lack such a wetting layer. Next, the polymer precursor material is cured, leading to a master 300 carrying a barrier layer 22 on a wetting layer 322 and a further barrier layer 24 on a wetting layer 324, as shown in FIG. 3c.

In a next step, an elastomeric material such as PDMS is deposited over the surfaces of the master 300 and developed to form an elastomeric stamp 10 as shown in FIG. 3d. In this process, the polymer material of the barrier layers 22 and 24 may form covalent bonds with the elastomeric material of the elastomeric stamp 10, or the polymer material of the barrier layers 22 and 24 may adhere more strongly to the stamp material than to the wetting layers 322 and 324 of the master 300, depending on the nature of the polymer and stamp materials used. In both cases, an elastomeric stamp 10 is achieved with a barrier layer 22 on the first surface 12 and a further barrier layer 24 on the second surface 14, as shown in FIG. 3e.

Provided that the polymer precursor material used to form the barrier layers 22 and 24 and the elastomeric material used to form the elastomeric stamp 10 remain at least partially phase separated, the elastomeric material may also be deposited directly over the polymer precursor material prior to the curing step of the polymer precursor material. Subsequently, the development step to form the elastomeric stamp 10 and the curing step to form the barrier layer 22 and further barrier 24 may be executed as a parallel or even one-step process.

A large advantage of the production method depicted in FIG. 3a-e is that the master 300 may be reused for the production of a multitude of stamps, without having to repeat the anisotropic modification step of the master 300.

Another way of providing a stamp 10 with a barrier layer 22 is shown in FIG. 4. The first surface 12 of the stamp 10 shown in FIG. 3a may be subjected to an oxidizing agent 400 such as a peroxide, as shown in FIG. 4b. Consequently, the first material of the stamp 10 is oxidized at the contact surfaces with the oxidizing agent 400, thus forming a stamp 10 having a barrier layer 22 on the first surface 12, with the barrier layer 22 comprising the first material in an oxidized form, as shown in FIG. 3c.

An elastomeric stamp 10 also having a further barrier layer 24 of oxidized first material on the second surface 14 may be formed as follows. All surfaces of the stamp may, for instance, be covered or soaked with a photosensititive reagent. Subsequently, the elastomeric stamp 10 may be subjected to irradiation directed substantantially perpendicular to the first surface 12 and the second surface 14. This at least partially initiates the oxidation reaction of the first material on these surfaces, while the directionality of the irradition effectively suppresses the oxidation reaction on the third surface 16.

The photosensitive reagent may be any known radical photoinitiators as used in photochemical polymerizations, especially peroxides such as dibenzoylperoxide or di(-tertiary-butyl)peroxide. Other photosensitive reagents that generate highly reactive species, such as radicals or ions, with a strong oxidative power may also be used.

FIG. 5 a-d show an embodiment of the method for printing an ink in a pattern on a substrate of an electronic device with an elastomeric stamp 10 of the present invention. In FIG. 5a, the elastomeric stamp 10 is brought into contact with a supply 510 of a solution including an ink 520. Since the elastomeric stamp 10 is at least partially formed from a first material that is permeable to the ink 520, the first material of the elastomeric stamp 10 will absorb the solution including the ink 520, leading to an ink-filled elastomeric stamp 10 as shown in FIG. 5b. For example, the elastomeric stamp 10 may be at least partially formed from PDMS, whereas the ink 520 may be a hydrophilic ink comprising a thiol functionality, e.g., 11—mercaptoundecanoic acid, which is supplied by Aldrich, and which may be dissolved in a suitable solvent such as ethanol in a concentration that typically lies in the millimole domain, e.g., 10 mM. However, it is emphasized that one of the advantages of the present invention lies in the fact that a wide variety of inks may be used with the elastomeric stamp 10, which may be of a hydrophilic nature such as the aforementioned 11mercaptoundecanoic acid, but may also be of a hydrophobic nature, such as alkanethiols including dodecanethiol and octadecanethiol, which are also provided by Aldrich. The elastomeric stamp 10 is subsequently rinsed with a solvent, e.g., ethanol to remove traces of the ink 520 from the surface of the barrier layer 22, and dried afterwards, e.g., by a nitrogen flow.

In a next step, as shown in FIG. 5c, the layers 22 of the second material on the first surface 12 of the elastomeric stamp 10 are brought into contact with a substrate 500, which may be part of an electronic device or a part of an intermediate component for such a device. The substrate 500, which for instance may be a silicon wafer, carries an additional layer 502 for receiving the molecular ink 520 in a pattern dictated by the shape of the elastomeric stamp 10. When using thiol-based inks 520, the additional layer 402 preferably comprises a coinage metal, e.g., a noble metal layer such as a gold layer having a thickness of 10-50 nm, although the choice of other metals and other thicknesses for the layer 502 are also feasible.

The molecular ink 520 is transferred from the elastomeric stamp 10 to the substrate layer 502 of the substrate 500 through diffusion from the first material via the third surface 16, as indicated by the solid arrows. This way, a self-assembled monolayer of ink molecules is formed on the layer 502 of the substrate 500 in the shape of the pattern of the stamp 10. It will be appreciated by those skilled in the art that this is an improved form of ETL, because the ink reservoir is no longer kept in a recess of the stamp, but is kept in the first material of the stamp 10 itself, thus leading to a much larger ink volume.

If the contact time between the elastomeric stamp 10 and the substrate layer 502 is kept relatively short, the printing method of the present invention is capable of printing ‘hollow’ features 512, i.e., features that are bordered by a SAM, on the layer 502, as shown in FIG. 5d. Obviously, the feature shapes are not limited to the square hollow features 512 shown in FIG. 5d. For instance, other hollow shapes, e.g., circles, parallelograms and so on, as well as linear features may also be formed. The use of hydrophobic inks such as dodecanethiol and octadecanethiol is particularly suited for the definition of such features, because hydrophobic inks tend to exhibit very limited spreading behaviour over the surface 502, which facilitates the formation of high-definition, open patterns.

At this point, it is emphasized that if no further barrier layer 24 is present on the second surface 14, gas phase diffusion of the ink 520 from the second surface 14 as well as from the third surface 16 may also take place, as indicated by the dashed arrows in FIG. 4c. The gas phase diffusion becomes more pronounced with increasing ink vapour pressures at the printing temperature, i.e., with inks having boiling points in the vicinity of the printing temperature. It will be understood that this is an unwanted effect when hollow or other high-definition features are required, because the gas phase diffusion can cause blurring of the desired pattern.

This can be avoided by the presence of further barrier layers 24 on the second surfaces 14 of the elastomeric stamp 10. The presence of a further barrier layer 24 has the advantage that a second surface 14 can be brought much closer to the substrate layer 502 than in the case of prior art stamps where the distance of the second surface 14 to the substrate layer 502 had to be kept as large as 300 nm to limit the unwanted effects of gas phase diffusion. Due to the closer orientation of the second surface 14 to the substrate layer 502, the area of the third surface 16 and the gas phase diffusion from the third surface 16 to the substrate layer 502 are reduced. A further advantage of the reduced distance between the second surface 14 and the substrate layer 502 is that the protruding features of the stamp are less likely to distort when into contact with the substrate layer 502, thus yielding improved feature definition. Also, the protruding features of the elastomeric stamp 10 can be placed closer together as a consequence, thus allowing for a higher feature density.

If the contact time between the elastomeric stamp 10 and the substrate layer 502 is increased, the lateral ink diffusion over the surface of the layer 502 under the second surface 14 will cause the hollow features 512 to become partially or completely filled with the ink 520. In other words, by varying the contact time between the elastomeric stamp 10 and the layer 502, the thickness of the ink lines deposited by the elastomeric stamp 10 can be varied. Short contact times allow for the definition of thin lines, whereas long contact times allow for the features 512 to become completely covered with a SAM, thus yielding the filled features 514. Long contact times are feasible without deterioration of the pattern quality, because the unwanted diffusion of ink 520 to the areas of the layer 502 that are into contact with the barrier layer 22 is prevented by the impermeable nature of the barrier layer 22. When relatively thick lines or filled structures such as the filled structures 514 are required, it can be advantageous to use an ink 520 with a high spreading tendency, such as some hydrophilic inks, e.g., hydrophilic inks with low boiling points. The use of such hydrophilic inks can reduce the required contact times with the substrate layer 502. Also, if filled features such as the filled structures 514 are required, the further barrier layer 24 may be omitted, because the occurrence of gas phase diffusion from the second surface 14 to the substrate layer 502 contributes to the filling of such features.

The printing method of the present invention facilitates the deposition of a wide variety of SAM patterns. Such a SAM pattern may be used to act as a resist in a subsequent etching step. Alternatively, the SAM pattern may be used to act as a mask in a subsequent etch resist deposition step, after which the SAM and underlying layers are removed in a subsequent etch step. The SAM pattern may also be used as an anchor for the formation of a multi-layer structure on the substrate layer 502, which may be achieved by chemical reaction of the SAM with subsequently deposited materials on top of the SAM.

A subsequent etching step may be performed using known etching techniques; for instance, in the case of a gold layer 402 carrying a thiol-based SAM acting as a wet etch resist, an etching bath composition as disclosed in Langmuir, 18, 2374-2377 (2002), containing 1M KOH, 0.1 M K₂SO₃, 0.01 M K₃Fe(CN)₆, and 0.001 M K₄Fe(CN)₆ in water half saturated with n—octanol, may be used.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. An elastomeric stamp for printing a pattern on a substrate with an ink the stamp being at least partially formed from a first material, the stamp comprising a first surface in a first plane, a second surface in a second plane and a third surface extending from the first surface to the second surface the third surface being permeable to the ink the first surface comprising a barrier layer being substantially impermeable to the ink

2. An elastomeric stamp as claimed in claim 1, wherein the barrier layer is non-covalently bound to the first surface

3. An elastomeric stamp as claimed in claim 1, wherein the first barrier layer comprises an inorganic oxide.

4. An elastomeric stamp as claimed in claim 1, wherein the first barrier layer comprises a polymer material.

5. An elastomeric stamp as claimed in claim 1, wherein the first barrier layer comprises the first material in a modified form.

6. An elastomeric stamp as claimed in claim 1, wherein the second surface comprises a further barrier layer being substantially impermeable to the ink

7. An elastomeric stamp as claimed in claim 6, wherein the first surface and the third surface form an angle between 60-90°.

8. An elastomeric stamp as claimed in claim 6, wherein the further barrier layer is of the same material as the barrier layer

9. A method for printing an ink in a pattern on a substrate of an electronic device using an elastomeric stamp the elastomeric stamp being at least partially formed from a first material, the elastomeric stamp comprising a first surface in a first plane, a second surface in a second plane and a third surface extending from the first surface to the second surface the third surface being permeable to the ink the first surface comprising a barrier layer being substantially impermeable to the ink the method comprising the steps of:
bringing the elastomeric stamp into contact with a supply of an ink solution;
absorbing the ink solution in the first material;
cleaning at least the barrier layer of the elastomeric stamp
drying the elastomeric stamp and
forming at least a part of the pattern by placing the elastomeric stamp on the substrate with the barrier layer contacting the substrate and transferring the ink from the first material to the substrate via the third surface

10. A method as claimed in claim 9, wherein the step of cleaning at least the barrier layer of the elastomeric stamp comprises rinsing the elastomeric stamp with a solvent.

11. A method of producing a patterned elastomeric stamp for printing an ink on a substrate of an electronic device, the method comprising the steps of:
providing a master having a first surface in a first plane, a second surface in a second plane and a third surface extending from the first surface to the second surface
depositing a first material precursor on said surfaces of the master
generating an elastomeric stamp having a first surface in a first plane, a second surface in a second plane and a third surface extending from the first surface to the second surface by transforming the first material precursor to a first material, said surfaces of the elastomeric stamp being permeable to the ink and
forming a barrier layer on the first surface of the elastomeric stamp the barrier layer being impermeable to the ink

12. A method as claimed in claim 11, wherein the step of forming a barrier layer on the first surface of the elastomeric stamp comprises anisotropically depositing a metal on the first surface of the elastomeric stamp

13. A method as claimed in claim 12, further comprising the step of oxidizing the barrier layer

14. A method as claimed in claim 11, wherein the step of forming a barrier layer on the first surface of the elastomeric stamp comprises forming a layer of polymer material on the first surface of the elastomeric stamp

15. A method as claimed in claim 14, wherein the step of forming a layer of a polymer material on the first surface of the elastomeric stamp comprises adhering a polymer material to the first surface of the elastomeric stamp

16. A method as claimed in claim 14, wherein the step of forming a layer of a polymer material on the first surface of the elastomeric stamp comprises depositing a precursor of the polymer material on the first surface of the elastomeric stamp and
forming the layer of the polymer material from the precursor.

17. A method as claimed in claim 16, wherein the step of forming the layer of the polymer material from the precursor is preceded by depositing a polymerization initiator on the first surface of the elastomeric stamp

18. A method as claimed in claim 14, further comprising
the steps of: modifying the first surface of the master and
depositing a precursor of the polymer material on the modified first surface of the master

19. A method as claimed in claim 11, wherein the step of forming a layer of a second material on the first surface comprises modifying a layer of the first material at the first surface

20. A method as claimed in claim 11, further comprising the step of forming a further barrier layer on the second surface of the elastomeric stamp the further barrier layer being impermeable to the ink.

21. A method as claimed in claim 20, wherein the further barrier layer is formed from a same material as the barrier layer
